(19) United States
(12) Patent Application Publication
(10) Pub. No.: US 2017/0097817 A1
(43) Pub. Date: Apr. 6, 2017

(54) METHOD FOR AUTOMATICALLY INSTALLING APPLICATION INTO PERSONAL COMPUTER

(71) Applicant: I/O INTERCONNECT INC., Taipei (TW)

(72) Inventor: Cheng-Hui Pu, Taipei (TW)

(21) Appl. No.: 15/386,575

(22) Filed: Dec. 21, 2016

Related U.S. Application Data
(63) Continuation-in-part of application No. 14/857,941, filed on Sep. 18, 2015.
Application No. 14/857,941 is a continuation-in-part of application No. 14/607,046, filed on Jan. 27, 2015.

(51) Int. Cl. G06F 9/445; H04W 4/00; H04L 29/08

(52) U.S. Cl. CPC G06F 8/61; H04L 67/34; H04L 67/02; H04W 4/001

(57) ABSTRACT

A method for automatically installing an application into a personal computer is provided herein. The personal computer has a port actuated by a first driver in the personal computer. The method includes steps of: (a) detecting whether a mobile device is electrically coupled to the port of the personal computer through a USB cable including a memory which stores the application; (b) installing the application including a second driver in the personal computer to substitute for the first driver to control the port; (c) sending a command to the mobile device to make the personal computer as an accessory device for the mobile device based on the second OS system; (d) detecting whether the mobile device has a predetermined program; (e) downloading and installing the predetermined program in the mobile device; and (f) transmitting and installing the predetermined program into the personal computer.

### RELATED APPLICATIONS

This application is a Continuation-in-part of U.S. application Ser. No. 14/857,941, filed on Sep. 18, 2015, which is a Continuation-in-part of U.S. application Ser. No. 14/607,046, filed on Jan. 27, 2015, the entire contents of which are hereby incorporated by reference herein.

### BACKGROUND OF THE INVENTION

Field of Invention

The present invention relates to a method for automatically installing an application into a personal computer. More particularly, the present invention relates to a method for automatically installing an application into a personal computer through a USB cable including a memory which stores the application.

Description of Related Art

Mobile devices, such as smartphones and tablets, have become essential for most people. These mobile devices are installed with many applications (also known as “apps”) that perform various functions. Some applications, which perform functions of cooperativity between a mobile device and a personal computer such as a desktop or a laptop computer, need to be installed into both the mobile device and the personal computer. A possible way is to use a USB (universal serial bus) cable with an installing device equipped with a memory, and in which a complete software program, including a personal computer version and a mobile device version, is stored. This cable is then used to connect a mobile device and a personal computer.

Although the said software program can automatically install the mobile device version and the personal computer version of the software program into the mobile device and the personal computer, respectively, the capacity of the memory must be large enough to store the complete software program. This in turn will increase the manufacturing cost of the USB cable.

In view of the foregoing, problems and disadvantages are associated with existing products that require further improvement. However, those skilled in the art have yet to find a solution.

### SUMMARY OF THE INVENTION

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a method for automatically installing an application into a personal computer, wherein the personal computer is based on a first OS system and has at least one port actuated by a first driver in the personal computer, wherein the method comprises steps of: (a) detecting whether a mobile device is electrically coupled to the at least one port of the personal computer through a USB cable comprising a memory which stores the application to proceed to step (b) if the mobile device is electrically coupled to the personal computer through the USB cable, or to repeat step (a) if the mobile device is not electrically coupled to the personal computer through the USB cable, wherein the mobile device is based on a second OS system; (b) installing the application comprising a second driver in the personal computer to substitute for the first driver to control the at least one port; (c) sending a command to the mobile device to make the personal computer as an accessory device for the mobile device based on the second OS system; (d) detecting whether the mobile device has a predetermined program to proceed to step (e) if the mobile device does not have the predetermined program; (e) downloading and installing the predetermined program into the mobile device; and (f) transmitting the predetermined program to the personal computer, and installing the predetermined program into the personal computer.

In view of the foregoing, embodiments of the present disclosure provide a method for automatically installing the application into the personal computer to improve the problems that the capacity of the memory of the USB cable must be large enough to store a complete software application.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a schematic diagram of an arrangement of a personal computer, a mobile device, and a USB cable according to embodiments of the present invention; and

FIG. 2 is a flow diagram illustrating the process steps of a method for automatically installing an application into a personal computer according to embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

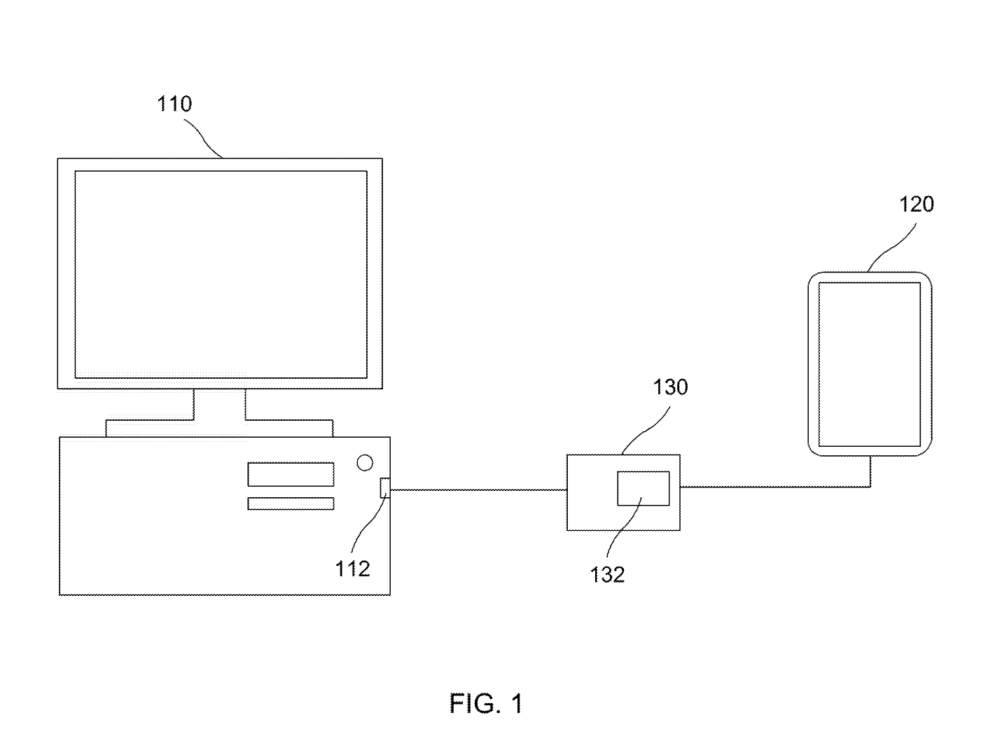

FIG. 1 is a schematic diagram of an arrangement of a personal computer 110, a mobile device 120, and a USB cable 130 according to embodiments of the present invention. As shown in FIG. 1, the personal computer 110 is based on a first OS system, and the mobile device 120 is based on a second OS system. The personal computer 110 has at least one port 112 actuated by a first driver in the personal computer 110.

In an embodiment, the port 112 is adapted to electrically couple the mobile device 120 through the USB cable 130. In another embodiment, the port 112 can be but not limited to a USB port, and the first driver can be but not limited to a standard USB driver correspondingly. In still another embodiment, the USB cable 130 includes a memory 132, and the memory 132 can store an application.

In some embodiments, the personal computer 110 can be but not limited to a desktop computer or a laptop computer, and the mobile device 120 can be but not limited to a smartphone or a tablet. In another embodiment, the personal computer 110 is based on the first OS system, for example, a Windows™ system, and the mobile device 120 is based on the second OS system, for example, an Android™ system. In yet another embodiment, the mobile device 120 supports Android Open Accessory.

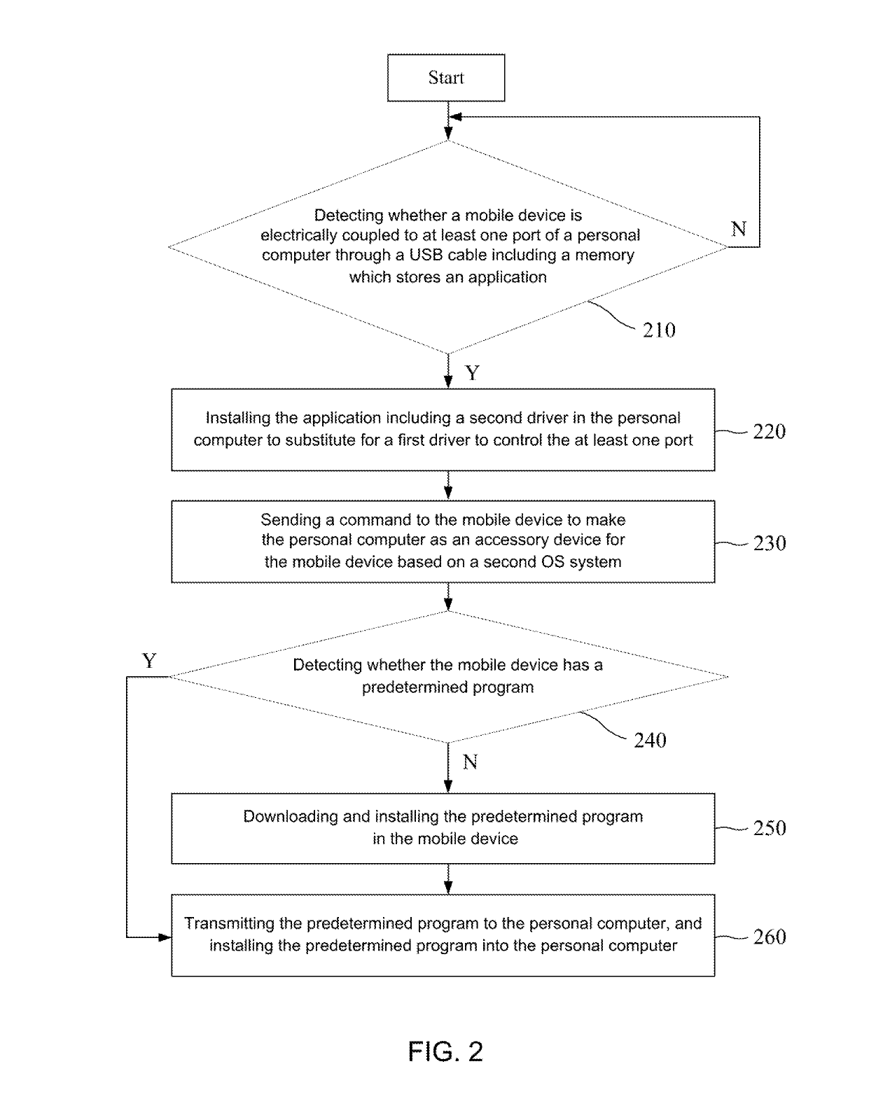

For facilitating understanding of a method for automatically installing an application into the personal computer 110, please referring to FIG. 2, which is a flow diagram illustrating the process steps of the method 200 for automatically installing the application into the personal computer 110 according to embodiments of the present disclosure. As shown in FIG. 2, the method 200 comprises steps of:

Step 210: detecting whether a mobile device is electrically coupled to at least one port of a personal computer through a USB cable including a memory which stores an application;

Step 220: installing the application including a second driver in the personal computer to substitute for a first driver to control the at least one port;

Step 230: sending a command to the mobile device to make the personal computer as an accessory device for the mobile device based on a second OS system;

Step 240: detecting whether the mobile device has a predetermined program;

Step 250: downloading and installing the predetermined program in the mobile device; and

Step 260: transmitting the predetermined program to the personal computer, and installing the predetermined program into the personal computer.

Reference is now made to both FIG. 1 and FIG. 2. In step 210, the personal computer 110 is configured to detect whether the mobile device 120 is electrically coupled to the at least one port 112 of the personal computer 110 through the USB cable 130 including the memory 132 which stores the application. For example, if the mobile device 120 is electrically coupled to the personal computer 110 via the port 112, the personal computer 110 will detect that they are connected to each other through the USB cable 130; subsequently, the method 200 proceeds to the step 220. On the contrary, if the personal computer 110 does not detect that the mobile device 120 is electrically coupled to the personal computer 110 via the port 112, the method 200 repeats the step 210.

In step 220, the application including the second driver is installed in the personal computer 110 to substitute for the first driver to control the at least one port 112. For example, there is a software application stored in the memory 132 of the USB cable 130. If the personal computer 110 detects that the mobile device 120 is electrically coupled to the personal computer 110 through the USB cable 130, the software application will automatically install the second driver to substitute for the first driver to control the port 112.

In step 230, the personal computer 110 is configured to send the command to the mobile device 120 to make the personal computer 110 as an accessory device for the mobile device 120 based on the second OS system. For example, when the mobile device 120 firstly connects to the personal computer 110 through the port 112, the mobile device 120 is regard as a slave (a MTP device), and the personal computer 110 is regard as a host based on the first OS system (i.e., Windows OS system). The step 230 is executed to change the authority among the personal computer 110 and the mobile device 120. After the mobile device 120 receives the command sent from the personal computer 110, the mobile device 120 is regard as a host, and the personal computer 110 is regard as a slave (Android Accessory) based on the second OS system (i.e., Android™ OS system).

In step 240, when the authority between the personal computer 110 and the mobile device 120 has been changed, the mobile device 120 will be detected that whether the mobile device 120 has a predetermined program or not. For example, if the authority has been changed and the mobile device 120 does not have the predetermined program, the method 200 proceeds to the step 250. On the contrary, if the authority has been changed and the mobile device 120 has the predetermined program, the method 200 proceeds to the step 260.

In step 250, the mobile device 120 is configured to download the predetermined program, and the predetermined program is installed into the mobile device 120. For example, if the authority has been changed and the mobile device 120 does not have the predetermined program, the mobile device 120 will be directed to a predetermined website (i.e., Google Play); subsequently, the predetermined website (i.e., Google Play) may show an installing page with an installing button regarding the predetermined program, and pressing the install button will download and install the predetermined program in the mobile device 120.

In step 260, the mobile device 120 is configured to transmit the predetermined program to the personal computer 110, and the predetermined program is installed into the personal computer 110. For example, if the authority has been changed and the mobile device 120 has the predetermined program, the mobile device 120 is now regard as a host; substantially, the mobile device 120 can transmit the predetermined program to the personal computer 110, and the predetermined program is installed into the personal computer 110.

In view of above, the method 200 of the present disclosure merely needs the memory 132 of the USB cable 130 with a low capacity for storing a small software application. Such software application only needs to be installed in the personal computer 110 for replacing the driver for driving the port 112 of the personal computer 110. Therefore, the method 200 for automatically installing the application into the personal computer 110 may improve the problems that the capacity of the memory of the USB cable must be large enough to store a complete software application in the prior art. Since the capacity of the memory 132 of the USB cable 130 is low, the manufacturing cost of the USB cable 130 can be reduced accordingly.

Further, as may be appreciated by persons having ordinary skill in the art, the steps of the method 200 are named according to the function they perform, and such naming is provided to facilitate the understanding of the present disclosure but not to limit the steps. Combining the step into a single step or dividing any one of the steps into multiple steps, or switching any step so as to be a part of another step falls within the scope of the embodiments of the present disclosure.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for automatically installing an application into a personal computer, wherein the personal computer is based on a first OS system and has at least one port actuated by a first driver in the personal computer, wherein the method comprises steps of:
(a) detecting whether a mobile device is electrically coupled to the at least one port of the personal computer through a USB cable comprising a memory which stores the application to proceed to step (b) if the mobile device is electrically coupled to the personal computer through the USB cable, or to repeat step (a) if the mobile device is not electrically coupled to the personal computer through the USB cable, wherein the mobile device is based on a second OS system;
(b) installing the application comprising a second driver in the personal computer to substitute for the first driver to control the at least one port;
(c) sending a command to the mobile device to make the personal computer as an accessory device for the mobile device based on the second OS system;
(d) detecting whether the mobile device has a predetermined program to proceed to step (e) if the mobile device does not have the predetermined program;
(e) downloading and installing the predetermined program in the mobile device; and
(f) transmitting the predetermined program to the personal computer, and installing the predetermined program into the personal computer.

2. The method of claim 1, wherein the mobile device supports Android Open Accessory.

3. The method of claim 1, wherein the first OS system comprises a Windows system.

4. The method of claim 1, wherein the second OS system comprises an Android system.

5. The method of claim 1, wherein the at least one port comprises a USB port.

6. The method of claim 1, wherein the first driver comprises a standard USB driver.

7. The method of claim 1, wherein the mobile device comprises a smartphone or a tablet.

8. The method of claim 1, wherein the personal computer comprises a desktop or a laptop computer.

9. The method of claim 1, wherein the step (d) of detecting whether the mobile device has the predetermined program comprises:
proceeding to step (f) if the mobile device has the predetermined program.

10. The method of claim 1, wherein the step (e) of downloading and installing the predetermined program in the mobile device comprises:
directing the mobile device to a predetermined website for downloading the predetermined program.
